(19) United States
(12) Patent Application Publication
(10) Pub. No.: US 2025/0105580 A1
(43) Pub. Date: Mar. 27, 2025

(54) MULTI-CORE FIBER OPTICAL AMPLIFIER AND OPTICAL AMPLIFICATION METHOD

(71) Applicant: NEC Corporation, Tokyo (JP)

(72) Inventor: Yusuke SHIMOMURA, Tokyo (JP)

(73) Assignee: NEC Corporation, Tokyo (JP)

(21) Appl. No.: 18/643,118

(22) Filed: Apr. 23, 2024

(30) Foreign Application Priority Data
Sep. 25, 2023 (JP) 2023-160131

(51) Int. Cl. H01S 3/067; G02B 6/02

(52) U.S. Cl. CPC H01S 3/06783; G02B 6/02042

(57) ABSTRACT

A multi-core fiber optical amplifier includes: a multi-core excitation fiber configured to include a first core and a second core; and a clad excitation circuit configured to inject excitation light into a clad of the multi-core excitation fiber, wherein signal light input to one end of the first core is output from the other end of the first core, the signal light output from the other end of the first core is input to one end of the second core, and the signal light input to one end of the second core is output from the other end of the second core.

This application is based upon and claims the benefit of priority from Japanese patent application No. 2023-160131, filed on Sep. 25, 2023, the disclosure of which is incorporated herein in its entirety by reference.

### TECHNICAL FIELD

The present disclosure relates to a multi-core fiber optical amplifier and an optical amplification method.

### BACKGROUND ART

Practical application of space division multiplexing systems using multi-core fibers (MCF) is under way. An MCF is an optical fiber including a plurality of cores. Use of an MCF in place of a single core fiber (SCF) enables expansion of transmission capacity of an optical transmission system. An MCF optical amplifier using an MCF as an excitation fiber (multi-core excitation fiber) is also known. A rare-earth element such as erbium (Er) is doped into a core of an MCF in such an excitation fiber. Two types of excitation being “core excitation” by which excitation light is directly injected into a core and “clad excitation” by which erbium in a plurality of cores is collectively excited by injecting excitation light into a clad are applicable to an MCF optical amplifier.

Wavelength division multiplexed signal light is normally used as signal light transmitted by an MCF. The C-band and the L-band are known as bands of wavelength division multiplexed signal light. The band of the C-band is roughly 1520 to 1560 nm, and the band of the L-band is roughly 1570 to 1610 nm. Wavelength division multiplexed signal light is hereinafter described as WDM light.

In relation to the present disclosure, an optical amplifier described in Japanese Unexamined Patent Application Publication No. 2013-058651 [patent literature 1: (PTL1)] is configured to include an excitation core in the central part and reflect signal light propagating through a signal light core around the excitation core by using a lens array and a mirror.

### SUMMARY

Signal light in the C-band is mainly used in transmission of a WDM signal. Then, transmission of a WDM signal using signal light in the L-band is also under study for further expansion of transmission capacity. However, efficiency in the L-band in a common optical fiber amplifier is lower than efficiency in the C-band. Therefore, an excitation fiber several times as long as that for the C-band needs to be used for amplification of signal light in the L-band using an optical fiber amplifier.

Each technology described in PTL 1 attempts to provide an effect of extending an excitation fiber by propagating one beam of signal light through a plurality of cores in an optical amplifier including an MCF as an excitation fiber. However, the technology described in PTL 1 requires use of a special MCF including a core for excitation at the center.

The present disclosure describes a technology for providing a multi-core fiber optical amplifier and an optical amplification method that enable effective utilization of a core of an MCF without using an excitation fiber using a special MCF.

A multi-core fiber optical amplifier according to the present disclosure is a multi-core fiber optical amplifier including: a multi-core excitation fiber configured to include a first core and a second core; and a clad excitation means for injecting excitation light into a clad of the multi-core excitation fiber, wherein
signal light input to an one end of the first core is output from an other end of the first core,
the signal light output from the other end of the first core is input to an one end of the second core, and
the signal light input to the one end of the second core is output from an other end of the second core.

An optical amplification method according to the present disclosure is an optical amplification method used in a multi-core fiber optical amplifier including a multi-core excitation fiber including a first core and a second core, the method including a procedure for:
injecting excitation light into a clad of the multi-core excitation fiber;
outputting signal light input to an one end of the first core from an other end of the first core;
inputting the signal light output from the other end of the first core to an one end of the second core; and
outputting the signal light input to the one end of the second core from an other end of the second core.

The present disclosure provides a multi-core fiber optical amplifier and an optical amplification method that enable effective utilization of a core of an MCF without using an excitation fiber using a special MCF.

### BRIEF DESCRIPTION OF THE DRAWINGS

Exemplary features and advantages of the present invention will become apparent from the following detailed description when taken with the accompanying drawings in which:

FIG. 1 is a diagram illustrating a configuration example of an MCF optical amplifier;

FIG. 2 is a diagram illustrating an example of a section of an excitation fiber;

FIG. 3 is a diagram illustrating an example of an optical path between end faces of an excitation fiber;

FIG. 4 is a diagram illustrating an example of an optical path between end faces of an excitation fiber;

FIG. 5 is a diagram illustrating an example of an optical path between end faces of an excitation fiber;

FIG. 6 is a diagram illustrating an example of an optical path between end faces of an excitation fiber;

FIG. 7 is a diagram illustrating an example of a scene in which end faces of an excitation fiber face each other;

FIG. 8 is a diagram illustrating an example of a scene in which end faces of an excitation fiber face each other;

FIG. 9 is a diagram illustrating an example of a scene in which end faces of an excitation fiber face each other;

FIG. 10 is a diagram illustrating an example of placement of cores of an excitation fiber;

FIG. 11 is a diagram illustrating an example of placement of cores of an excitation fiber;

FIG. 12 is a diagram illustrating an example of a scene in which end faces of an excitation fiber face each other;

FIG. 13 is a diagram illustrating an example of a scene in which end faces of an excitation fiber face each other; and

FIG. 14 is a diagram illustrating an example of a scene in which end faces of an excitation fiber face each other.

### EXAMPLE EMBODIMENT

### First Example Embodiment

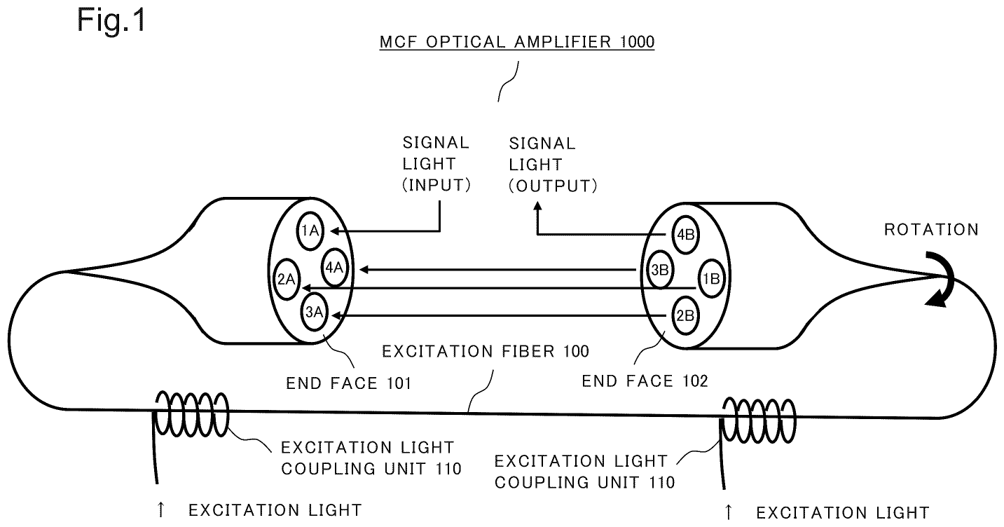

FIG. 1 is a diagram illustrating a configuration example of an MCF optical amplifier 1000 according to the present disclosure. The MCF optical amplifier 1000 is a multi-core fiber optical amplifier and includes an MCF including two or more cores as an excitation fiber 100. An excitation fiber is a multi-core excitation fiber in which a rare-earth element such as erbium is doped into cores. A case of the excitation fiber 100 including four cores (a core 1 to a core 4) will be described in FIG. 1. However, the number of cores in the excitation fiber 100 has only to be more than one and is not limited to four. End faces of the core 1 to the core 4 appearing at an end face 101 being an one end of the excitation fiber 100 are respectively represented by an end face 1A to an end face 4A in FIG. 1. End faces of the core 1 to the core 4 appearing at an end face 102 being an another end of the excitation fiber 100 are respectively represented by an end face 1B to an end face 4B. The end face 101 and the end face 102 face each other in parallel. The central axis of the excitation fiber 100 at the end face 101 and the central axis of the excitation fiber 100 at the end face 102 match. Furthermore, as will be described later, the end face 102 is positioned to be rotated 90 degrees around the central axis relative to the end face 101 in FIG. 1.

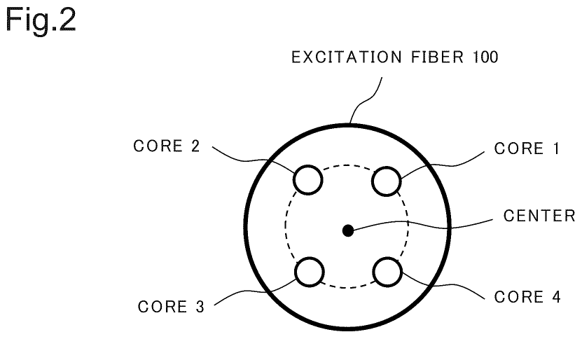

FIG. 2 is a diagram illustrating an example of a section of the excitation fiber 100. The excitation fiber 100 is an MCF with a circular section. The core 1 to the core 4 are equidistantly spaced on a circumference around the central axis of the excitation fiber 100. Therefore, when the excitation fiber 100 is rotated around the central axis, the positions of the core 1 to the core 4 on the section of the excitation fiber 100 overlap every 90 degrees. The position of the central axis in a longitudinal direction of an excitation fiber at an end face of the excitation fiber is hereinafter simply described as the “center of the excitation fiber.” The center of the excitation fiber 100 is represented by a black dot in FIG. 2.

The excitation fiber 100 illustrated in FIG. 1 includes an excitation light coupling unit 110 for injecting excitation light into a clad of the excitation fiber 100. The excitation light coupling unit 110 is a clad excitation circuit configured to inject excitation light into the clad of the multi-core excitation fiber. A widely known configuration may be applied to the excitation light coupling unit 110. For example, excitation light can be injected into the clad of the excitation fiber 100 by winding an optical fiber for propagating the excitation light around the excitation fiber 100 with the covering removed. The excitation fiber 100 amplifies signal light propagating through the core 1 to the core 4 by excitation of rare-earth ions doped into the core 1 to the core 4 by the excitation light injected into the clad (clad excitation light).

The excitation fiber 100 is configured in such a way that one end face (the end face 101) of the fiber and the other end face (the end face 102) face each other, and cores appearing at the end faces 101 and 102 are optically coupled on a one-to-one basis. Then, by applying rotation (a twist) to the end face 101 or the end face 102, signal light propagating through a core (such as the core 1) can be caused to propagate through the space between the end face 101 and the end face 102 and be input to another core (such as the core 2). Placement of cores illustrated in FIG. 1 is acquired by twisting the excitation fiber 100 90 degrees (that is, rotating the end face 101 or 102 90 degrees in a direction perpendicular to the central axis of the excitation fiber 100). The excitation fiber 100 may include a maintenance part in order to maintain the positional relation of the cores between the end face 101 and the end face 102. For example, the maintenance part is a member for simultaneously holding the neighborhood of the end face 101 of the excitation fiber 100 and the neighborhood of the end face 102 in a fixed manner.

When signal light is input to the end face 1A of the core 1 at the end face 101, the signal light propagates through the core 1 and is output from the end face 1B of the core 1 at the end face 102. As illustrated in FIG. 1, the signal light output from the end face 1B is input to the end face 2A of the core 2. Then, the signal light propagates through the core 2 and is output from the end face 2B of the core 2 at the end face 102. The signal light output from the end face 2B is input to the end face 3A of the core 3. The signal light propagates through the core 3 and is output from the end face 3B of the core 3 at the end face 102. The signal light output from the end face 3B is input to the end face 4A of the core 4. The signal light input to the end face 4A of the core 4 propagates through the core 4 and is output from the end face 4B of the core 4 at the end face 102. The signal light output from the end face 4B is output to outside the excitation fiber 100.

Japanese Unexamined Patent Application Publication No. 2014-021225 describes an optical amplifier configured to input signal light and excitation light from the outer periphery of an MCF by using a coupler. However, the optical amplifier described in Japanese Unexamined Patent Application Publication No. 2014-021225 inputs signal light and excitation light to an excitation fiber by using the coupler and therefore can only use a core close to the outer periphery of the excitation fiber for optical amplification. On the other hand, the MCF optical amplifier 1000 can utilize a core at any position in the excitation fiber for optical amplification as long as the cores are optically connected between the end face 101 and the end face 102.

With such a configuration, the MCF optical amplifier 1000 described in the present example embodiment enables effective utilization of a core of an MCF without using an excitation fiber using a special MCF.

Signal light input to the core 1 propagates through the core 1, the core 2, the core 3, and the core 4 in this order and is output from the core 4. Then, by injection of clad excitation light into the excitation fiber 100, the signal light is amplified in each core while propagating through the core 1 to the core 4. In other words, the MCF optical amplifier 1000 amplifies the signal light by using four cores of one excitation fiber 100, and therefore the length of an excitation fiber through which the signal light propagates is the quadruple of that of an excitation fiber using an SCF of the same length as the excitation fiber 100. As a result, the MCF optical amplifier 1000 can shorten the length of an excitation fiber required for optical amplification compared with an optical amplifier using an SCF as an excitation fiber.

### Another Expression of First Example Embodiment

The effects of the MCF optical amplifier 1000 described above are provided also by a multi-core fiber optical amplifier with the following configuration. A reference sign in FIG. 1 related to each component is indicated in parentheses.

A multi-core fiber optical amplifier (1000) includes a multi-core excitation fiber (100) including a first core and a second core, and a clad excitation circuit (110) configured to inject excitation light into a clad of the multi-core excitation fiber (100). The multi-core fiber optical amplifier (1000) is configured to output signal light input to one end (1A) of the first core from the other end (1B) of the first core. The multi-core fiber optical amplifier (1000) is further configured to input signal light output from the other end (1B) of the first core to one end (2A) of the second core and outputs the signal light input to the one end (2A) of the second core from the other end (2B) of the second core.

The first core (1) and the second core (2) may be equidistantly spaced on a circumference around the center of an end face of the multi-core excitation fiber (100). By maintaining one end (102) of the multi-core excitation fiber (100) in a state of being rotated by a predefined angle relative to the other end (101) of the multi-core excitation fiber, the other end (1B) of the first core may be optically coupled to the one end (2A) of the second core.

The multi-core fiber optical amplifier (1000) may include a third core. The multi-core fiber optical amplifier (1000) may be configured to input signal light output from the other end (2B) of the second core to one end (3A) of the third core and output the signal light input to the one end (3A) of the third core from the other end (3B) of the third core.

### Second Example Embodiment

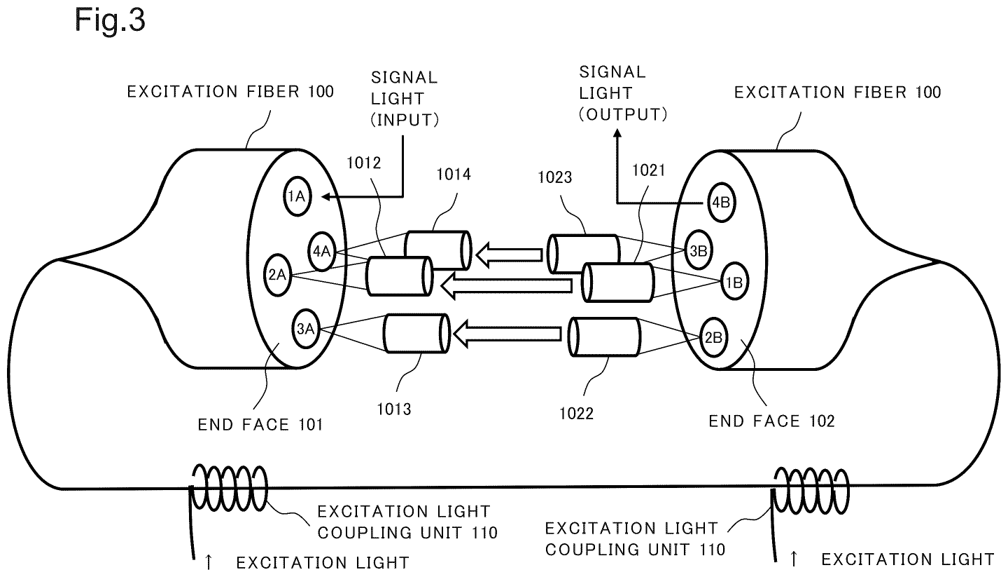

A configuration example of an optical path between an end face 101 and an end face 102 of an excitation fiber 100 will be described as a second example embodiment below. Each of FIG. 3 to FIG. 6 illustrates part of the configuration of the MCF optical amplifier 1000 in FIG. 1, and configurations in FIG. 3 to FIG. 6 are applicable to the MCF optical amplifier 1000.

FIG. 3 is a diagram illustrating a configuration example of an optical path between the end face 101 and the end face 102 of the excitation fiber 100 in the MCF optical amplifier 1000. In FIG. 3, the end face 1A of the core 1 and the end face 4B of the core 4 are placed in such a way as to face each other between the end face 101 and the end face 102. Similarly, the end face 1B and the end face 2A face each other, the end face 2B and the end face 3A face each other, and the end face 3B and the end face 4A face each other.

Optical coupling is performed between the end face 1B and the end face 2A by two optical collimators 1021 and 1012. The optical collimator 1021 is placed on the end face 102 side, and the optical collimator 1012 is placed on the end face 101 side. The optical collimator 1021 converts signal light output from the end face 1B into collimated light. The optical collimator 1012 condenses the collimated light output from the optical collimator 1021 and inputs the condensed light to the end face 2A. The optical axes of optical collimator 1021 and the optical collimator 1012 are adjusted in such a way that the core 1 is optically coupled to the core 2 between the end face 1B and the end face 2A. The signal light propagates between the optical collimator 1021 and the optical collimator 1012 as collimated light.

Two each of optical collimators are similarly used in coupling of the core 2 to the core 3 and coupling of the core 3 to the core 4, respectively, between the end face 101 and the end face 102. Specifically, an optical collimator 1022 and an optical collimator 1013 couple the core 2 to the core 3, and an optical collimator 1023 and an optical collimator 1014 couple the core 3 to the core 4. With such a configuration, signal light input to the end face 1A of the core 1 propagates through the core 1 to the core 4 and is output from the end face 4B of the core 4. Then, by injection of excitation light into the excitation fiber 100 from the excitation light coupling unit 110, the signal light is excited over a length quadruple to that of the excitation fiber 100. The optical collimators 1012 to 1014 and the optical collimators 1021 to 1023 may couple collimated light to each core by using a lens array.

In FIG. 3, the end face 1A of the core 1 and the end face 4B of the core 4 face each other between the end face 101 and the end face 102. However, the end face 1A is used for input of signal light, and the end face 4B is used for output. Accordingly, the end face 1A is not optically connected to the end face 4B in the space between the end face 101 and the end face 102. Any configuration is applicable as the configuration for inputting signal light to the end face 1A and the configuration for outputting signal light output from the end face 4B to the outside.

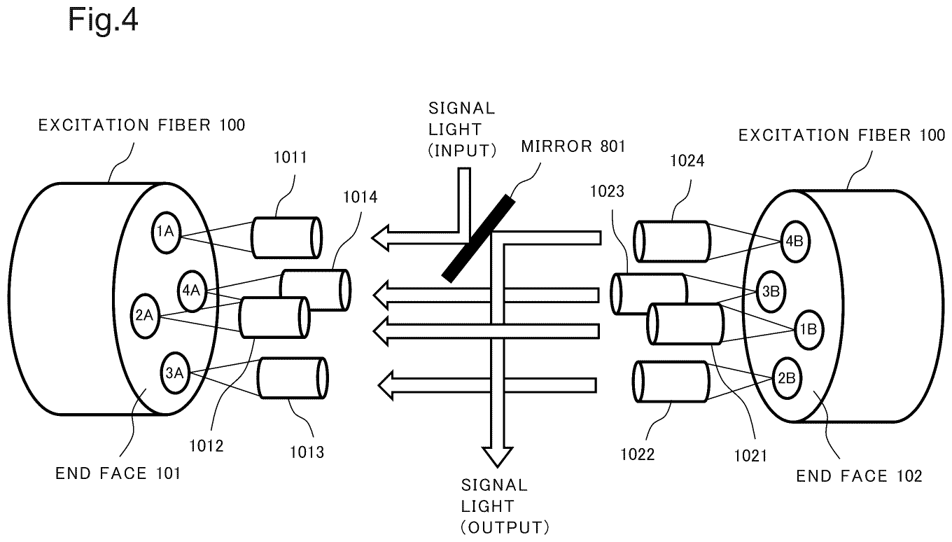

FIG. 4 is a diagram illustrating another configuration example of an optical path between the end face 101 and the end face 102. FIG. 4 to FIG. 6 illustrate only parts necessary for description. In FIG. 4, the end face 1A of the core 1 and the end face 4B of the core 4 face each other between the end face 101 and the end face 102, similarly to FIG. 3. As described above, the end face 1A is used for input of signal light, and the end face 4B is used for output of signal light. FIG. 4 illustrates a configuration including a mirror 801 for separating signal light input to the core 1 from signal light output from the core 4.

The mirror 801 is provided between the end face 1A and the end face 4B. Both faces of the mirror 801 reflect signal light. For example, the mirror 801 is a reflective film using a thin metal film. The end face 1A and the end face 4B face each other with an optical collimator 1011 and an optical collimator 1024 interposed in between. Then, the mirror 801 is placed in such a way as to make 45 degrees with an optical axis connecting the end face 1A to the end face 4B. With such a configuration, signal light introduced from outside the MCF optical amplifier 1000 as collimated light can be reflected off the mirror 801 and be guided to the end face 1A. Furthermore, signal light output from the end face 4B can be reflected off the mirror 801 and be taken out to outside the MCF optical amplifier 1000.

The reflective film in the mirror 801 may reflect signal light and excitation light. Then, when the signal light is guided to the end face 1A, signal light multiplexed with the excitation light may be input to the end face 1A through the mirror 801 and the optical collimator 1011. In general, wavelength bands of excitation light and signal light do not overlap each other. For example, the wavelength of excitation light is in the 980 nm band, and the wavelength of signal light is in the C-band or the L-band (that is, roughly 1520 nm to 1610 nm). Accordingly, by wavelength division multiplexing excitation light and signal light by using a wavelength filter and converting the signal light wavelength division multiplexed with the excitation light into collimated light, the excitation light and the signal light can be input to the core 1 on the same optical path. Excitation light directly input to a core is hereinafter described as core excitation light.

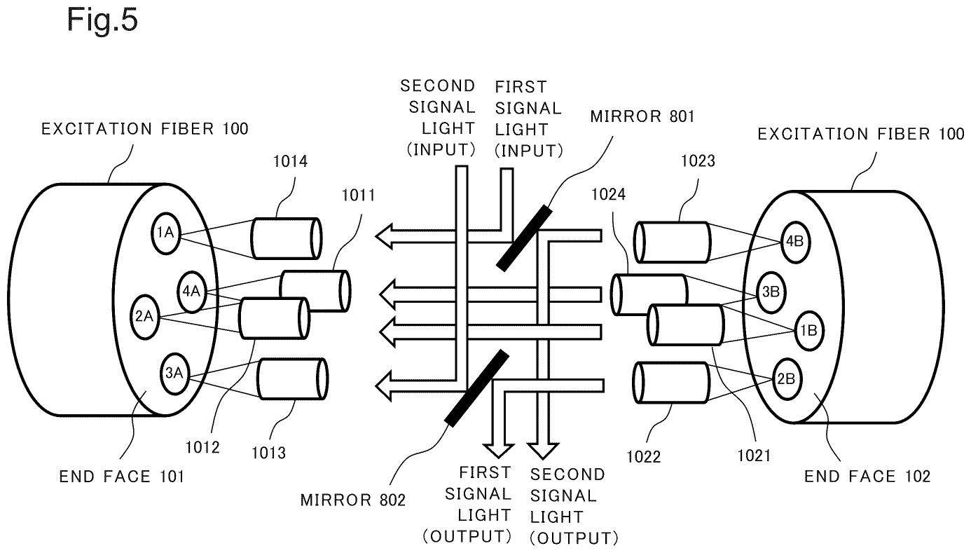

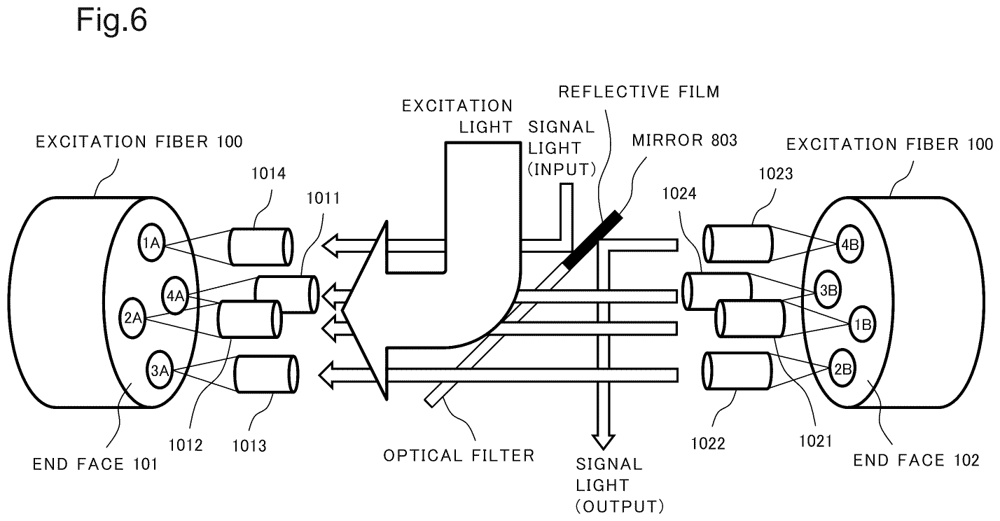

With core excitation light input from the mirror 801, the core 1 can amplify signal light by core excitation in addition to clad excitation by the excitation light coupling unit 110. Core excitation light remaining in the core 1 without being used for amplification may be input to the core 2 through the end face 1B, the optical collimators 1021 and 1012, and the end face 2A. The core excitation light input to the core 2 may further propagate to the core 3 and the core 4 with signal light. In the configuration in which excitation light and signal light are multiplexed and are input to the core 1, the mirror 801 is optional. In other words, the configuration is applicable to the configurations without the mirror 801 that are illustrated in FIG. 1 and FIG. 3. Furthermore, the configuration in which signal light multiplexed with excitation light is input to a core from the end face 101 is also applicable to configurations in FIG. 5 and FIG. 6 to be described later.

FIG. 5 is a diagram illustrating another configuration example of an optical path between the end face 101 and the end face 102. The configuration in FIG. 5 differs from the configuration in FIG. 4 in further including a mirror 802. The mirror 802 is provided between the end face 3A of the core 3 and the end face 2B of the core 2. Both faces of the mirror 802 reflect signal light. For example, the mirror 802 is a reflective film using a thin metal film. The end face 3A and the end face 2B face each other with the optical collimator 1013 and the optical collimator 1022 interposed in between. The mirror 802 is placed in such a way as to make 45 degrees with an optical axis connecting the end face 3A to the end face 2B.

With such a configuration, second signal light introduced from outside the MCF optical amplifier 1000 as collimated light can be reflected off the mirror 802 and be input to the core 3. The second signal light input to the core 3 propagates through the core 3 and the core 4 and is output to the outside by the mirror 801. On the other hand, first signal light input to the core 1 by the mirror 801 propagates through the core 1 and the core 2, is output from the end face 2B of the core 2, and is output to the outside by the mirror 802.

FIG. 5 illustrates a configuration example of placing mirrors according to the number of beams of signal light to be amplified. In the example in FIG. 5, by using the four cores 1 to 4 by twos, two beams of signal light can be amplified by using one excitation fiber 100. Further, by changing the positions of the mirrors, the lengths of cores through which two beams of signal light propagate can be changed. In FIG. 5, the first signal light propagates through the core 1 and the core 2, and the second signal light propagates through the core 3 and the core 4.

However, for example, when the mirror 802 is placed between the optical collimator 1012 and the optical collimator 1021, the first signal light propagates only through the core 1, and the second signal light on the other hand propagates through the core 2 to the core 4. Changing the position of the mirror 801 similarly allows the length of a core through which each of a plurality of beams of signal light propagates to be changed. Therefore, the configuration in FIG. 5 enables selection of the length of a core according to an amplification factor required of signal light and therefore can amplify each of a plurality of beams of signal light under a preferable condition.

FIG. 6 is a diagram illustrating another configuration example of an optical path between the end face 101 and the end face 102. FIG. 6 illustrates a configuration including a mirror 803 in place of the mirror 801 in FIG. 4. The mirror 803 is formed of a reflective film and an optical filter. The reflective film is formed only in a part necessary for reflecting signal light input to the end face 1A and signal light output from the end face 4B. The other part of the mirror 803 is the optical filter. The optical filter transmits light at the wavelength of signal light and reflects light at the wavelength of excitation light. For example, the optical filter is formed of a dielectric multilayer film. The reflective film may reflect both signal light and excitation light.

The mirror 803 is placed in such a way as to make 45 degrees with collimated light connecting the end face 1A to the end face 4B. In this case, the mirror 803 also makes an angle of 45 degrees with collimated light connecting other cores between the end face 101 and the end face 102. The optical axis of the optical collimator 1012 and the optical axis of the optical collimator 1021 are adjusted in such a way that the collimators are optically coupled by signal light passing through the optical filter in the mirror 803. The same holds for the optical axis of the optical collimator 1013 and the optical axis of the optical collimator 1022, and the optical axis of the optical collimator 1014 and the optical axis of the optical collimator 1023. With such a configuration, the mirror 803 reflects excitation light incident from a direction perpendicular to an optical axis connecting cores between the end face 101 and the end face 102. The excitation light incident on the mirror 803 can be generated by converting light output from a common excitation light source into collimated light with roughly the same diameter as that of the excitation fiber 100 by an optical collimator.

Excitation light reflected off the mirror 803 passes between the optical collimators 1011 to 1014 and is input to the clad of the excitation fiber 100 at the end face 101. On the other hand, the optical filter part of the mirror 803 transmits signal light, and therefore signal light propagating through the core 1 to the core 4 in a sequential order is not affected by the mirror 802. As a result, the excitation fiber 100 amplifies the signal light propagating through the core 1 to the core 4 by clad excitation.

Part of the excitation light reflected off the mirror 803 is input to the end faces 1A to 4A through the optical collimators 1011 to 1014. The excitation light input to the end face 1A to 4A excites the core 1 to the core 4 as core excitation light. In other words, the configuration in FIG. 6 can simultaneously achieve clad excitation and core excitation of the excitation fiber 100 with one beam of excitation light. When core excitation is not necessary, an optical filter blocking excitation light and transmitting signal light may be formed at the lens of an optical collimator. Thus, excitation light being reflected off the mirror 803 and traveling in the direction of the end face 101 can be used only for clad excitation of the excitation fiber 100.

Thus, the mirror 803 has a function of inputting excitation light to the clad of the excitation fiber 100 in addition to a function of inputting and outputting signal light. Accordingly, the mirror 803 has the function of the excitation light coupling unit 110 illustrated in FIG. 1. The mirror 803 may cause residual excitation light output from the clad of the end face 102 to reflect and take the light out of the MCF optical amplifier 1000. The residual excitation light is excitation light not being used for excitation in the excitation fiber 100. The residual excitation light may be used for excitation of another excitation fiber.

The reflective film in the mirror 803 may have the functions of both mirrors 801 and 802 illustrated in FIG. 5. Specifically, the mirror 803 includes a reflective film at the position where an optical path on which signal light to be reflected propagates as collimated light and the mirror 803 cross each other. Then, a part of the mirror 803 other than the reflective film may be formed of an optical filter transmitting signal light and reflecting excitation light.

Both signal light and excitation light travel in the direction of the end face 101 in FIG. 6. Therefore, the excitation fiber 100 operates by forward excitation. However, the direction of excitation light input to the excitation fiber 100 may be opposite to that in FIG. 6. By inputting excitation light to the end face 102, the excitation fiber 100 can operate by backward excitation.

The MCF optical amplifier 1000 using an excitation fiber including four cores has been described in FIG. 1 to FIG. 6. However, the aforementioned configuration in which the end face 101 and the end face 102 are optically connected is also applicable to an excitation fiber with two or more cores by increasing or decreasing the number of optical collimators in parallel.

The configurations illustrated in FIG. 3 to FIG. 6 are applicable to the MCF optical amplifier 1000. Accordingly, the MCF optical amplifiers 1000 including the configurations enable effective utilization of a core of an MCF without using an excitation fiber using a special MCF.

### Third Example Embodiment

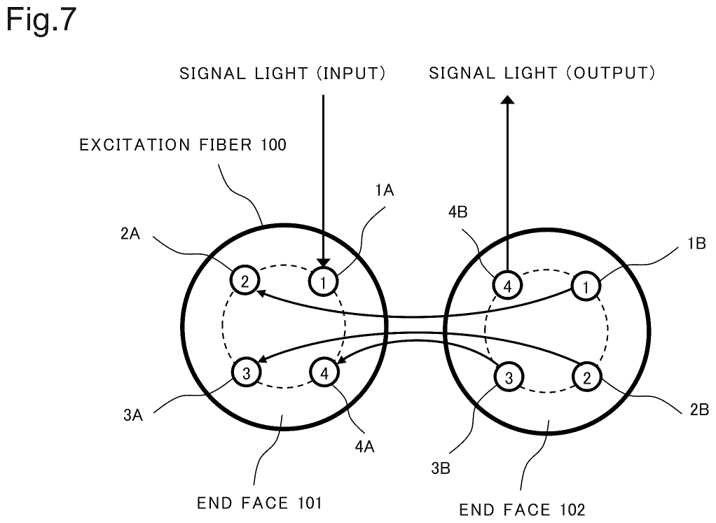

Excitation fibers with various types of core placement applicable to the MCF optical amplifier 1000 will be described as a third example embodiment below with reference to FIG. 7 to FIG. 14. Each of excitation fibers illustrated in FIG. 7 to FIG. 14 is applicable to the MCF optical amplifier 1000 in FIG. 1. Accordingly, MCF optical amplifiers 1000 to which the following configurations are applied also enable effective utilization of a core of an MCF without using an excitation fiber using a special MCF.

FIG. 7 to FIG. 14 are diagrams illustrating examples of an optical path of signal light between end faces of an excitation fiber out of excitation fibers with various types of core placement. The configurations described in FIG. 3 to FIG. 6 for optically connecting cores are also applicable to the excitation fibers illustrated in FIG. 7 to FIG. 14. Note that illustration of optical components such as an optical collimator and a mirror is omitted in the following drawings.

FIG. 7 illustrates a scene in which an end face 101 and an end face 102 of an excitation fiber 100 including four cores face each other. FIG. 7 illustrates a case of the end face 101 and the end face 102 of the excitation fiber 100 facing each other illustrated in FIG. 1 again. The end faces 101 and 102 in FIG. 7 represent a diagram of end faces of the excitation fiber 100 viewed from outside the excitation fiber 100, similarly to FIG. 1. The four cores are equidistantly spaced on a circumference around the center of the excitation fiber at a section of the excitation fiber 100. In other words, the position of each of adjacent cores of the excitation fiber 100 is at the position of the core when the section of the excitation fiber 100 is rotated 90 degrees.

An arrow in FIG. 7 schematically indicates a propagation path of signal light between cores. Signal light input to an end face 1A of a core 1 is output from an end face 1B of the core 1. Then, the excitation fiber 100 is rotated 90 degrees around the central axis of the excitation fiber 100 when the end face 101 and the end face 102 face each other. As a result, the end face 1B faces an end face 2A. The signal light output from the end face 1B is input to a core 2 from the end face 2A. Similarly, the signal light output from an end face 2B is input to an end face 3A, and the signal light output from an end face 3B is input to an end face 4A. Then, the signal light propagating through the core 1 to a core 4 is output from an end face 4B.

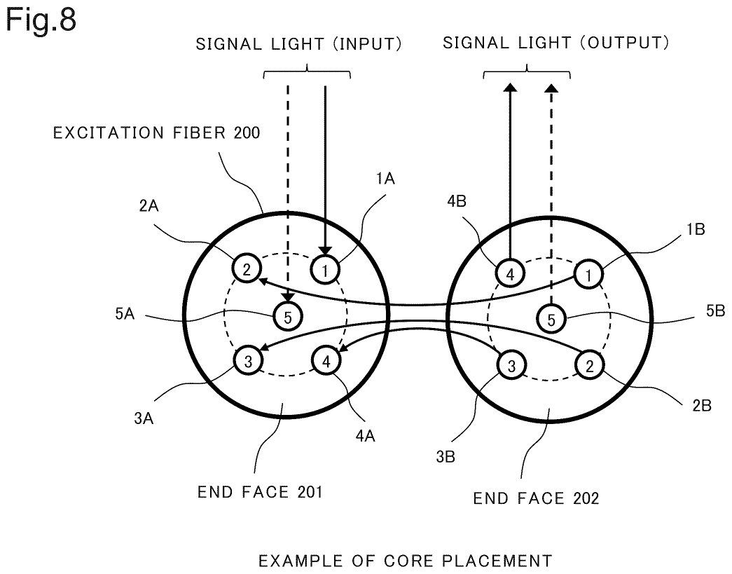

FIG. 8 is a diagram illustrating an example of core placement of an excitation fiber 200. The excitation fiber 200 includes a core (a core 5) along the central axis. The core 5 is not included in an optical path of signal light propagating through a core 1 to a core 4. The core 5 may be singly used as an optical amplifier with the length of one excitation fiber 100. For example, the core 1 to the core 4 may be used for amplification of signal light in the L-band, and the core 5 may be used for amplification of signal light in the C-band. An end face 5A and an end face 5B of the core 5 face each other between an end face 101 and an end face 102. Therefore, signal light can be input to and output from the core 5 by providing a mirror reflecting signal light propagating through the core 5 on an optical path connecting the end face 5A to the end face 5B. The mirror provides a function similar to that of the mirror 801 in FIG. 4. When the configuration in FIG. 5 is applied to the excitation fiber 200, the mirror on the optical path connecting the end face 5A to the end face 5B may be provided in a part of the mirror 802.

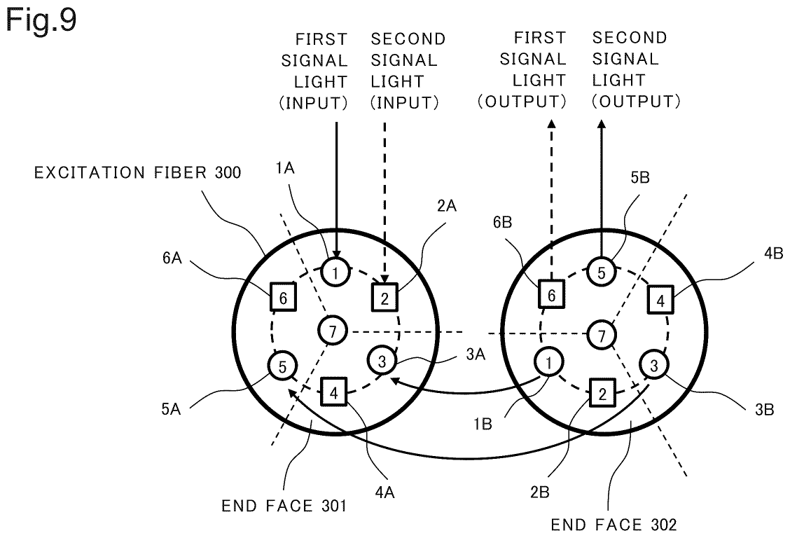

In an optical fiber amplifier using an erbium-doped excitation fiber, the L-band generally has lower amplification efficiency than the C-band. Therefore, in order to bring the gain of signal light in the L-band close to the gain of signal light in the C-band, an excitation fiber several times as long as an excitation fiber for the C-band needs to be separately prepared and be used as an excitation fiber for the L-band. By amplifying signal light by using the core 1 to the core 4, the excitation fiber 200 can provide an effect of extending the length of the excitation fiber and improving amplification efficiency. Accordingly, the excitation fiber 200 can amplify signal light in the C-band and signal light in the L-band with one excitation fiber and can reduce the difference in excitation efficiency between the C-band and the L-band. In other words, the MCF optical amplifier 1000 using the excitation fiber 200 enables downsizing of an optical amplifier. A core place at the center of an excitation fiber can be used for amplification of signal light in the C-band in and after FIG. 9 described below. Further, the core used for amplification in the C-band may not be the core at the center.

FIG. 9 is a diagram illustrating an example of core placement of an excitation fiber 300. The excitation fiber 300 includes six cores (a core 1 to a core 6) on the circumference of a circle around the center of the fiber and includes a core 7 along the central axis of the excitation fiber 300. The core 1 to the core 6 are equidistantly spaced on the circumference around the center of the excitation fiber 300. The excitation fiber 300 undergoes 120-degree left-hand rotation viewing an end face 302. Therefore, for example, an end face 3A of the core 3 faces an end face 1B of the core 1. Accordingly, first signal light being input to an end face 1A of the core 1 at the end face 301 and being output from the end face 1B is input to the end face 3A of the core 3. Then, the first signal light propagates through the core 3 and the core 5 and is output from an end face 5B of the core 5.

On the other hand, second signal light input to an end face 2A of the core 2 at the end face 301 is output from an end face 2B at an end face 302 and is input to an end face 4A of the core 4. The light propagates through the core 4 and the core 6 and is output from an end face 6B of the core 6. Thus, the cores of the excitation fiber 300 are divided into two groups (the cores 1, 3, and 5 and the cores 2, 4, and 6) and different signal light can be amplified for each group. The core 7 is not included in optical paths of light propagating through the cores 1 to 6. The core 7 may be singly used as an optical amplifier with the length of one excitation fiber 300, similarly to the excitation fiber 300 in FIG. 8. For example, the cores 1, 3, and 5 and the cores 2, 4, and 6 may be respectively used for amplification of different beams of signal light in the L-band, and the core 7 may be used for amplification of signal light in the C-band. The excitation fiber 300 can also amplify signal light in the C-band and signal light in the L-band with one excitation fiber and reduce the difference in excitation efficiency between the C-band and the L-band.

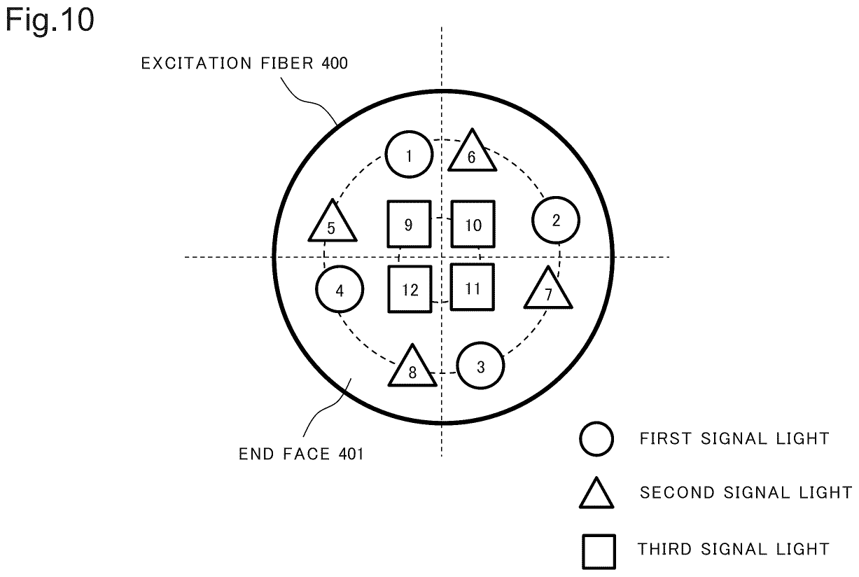

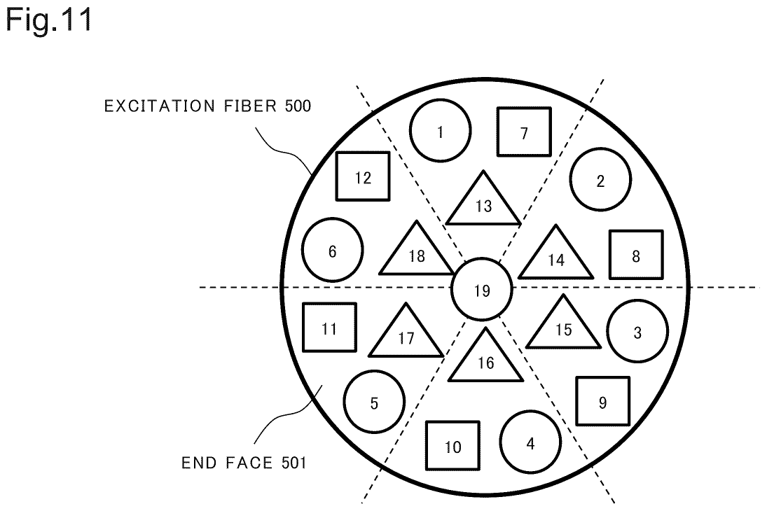

FIG. 10 is a diagram illustrating an example of core placement at an end face 401 of an excitation fiber 400. Illustration of core placement at the other end face of an excitation fiber is omitted in FIG. 10 and FIG. 11. The excitation fiber 400 includes 12 cores (a core 1 to a core 12). The core 1 to the core 4 are placed on a circumference around the center of the excitation fiber 400 and are equidistantly spaced on the circumference. The core 5 to the core 8 are equidistantly spaced on the same circumference as the core 1 to the core 4. The positions of the core 1 to the core 8 do not overlap each other. The core 9 to the core 12 are equidistantly spaced on the circumference of a circle with a smaller radius than that for the core 1 to the core 8. Accordingly, application of 90-degree rotation to the excitation fiber 400 can cause first signal light input from an one end face of the core 1 to propagate through the core 1 to the core 4 and be output from an other end face of the core 4, similarly to the excitation fibers 100 to 300. Similarly, second signal light input to an end face of the core 5 can be caused to propagate through the core 5 to the core 8 and be output from an end face of the core 8. Furthermore, third signal light input to an end face of the core 9 can be caused to propagate through the core 9 to the core 12 and be output from an end face of the core 12. Thus, by dividing the 12 cores into three groups by fours, the excitation fiber 400 can independently amplify the first to third signal light.

FIG. 11 is a diagram illustrating an example of core placement at an end face 501 of an excitation fiber 500. The excitation fiber 500 includes 19 cores (a core 1 to a core 19). The core 1 to the core 6 are placed on a circumference around the center of the excitation fiber 500 and are equidistantly spaced on the circumference. The core 7 to the core 12 are equidistantly spaced on the same circumference as the core 1 to the core 6. The positions of the core 1 to the core 12 do not overlap each other. The core 13 to the core 18 are equidistantly spaced on the circumference of a circle with a smaller radius than that for the core 1 to the core 12. Application of 60-degree rotation to the excitation fiber 500 can cause first signal light input to the core 1 from one end face of the excitation fiber 500 to propagate through the core 1 to the core 6 and be output from the core 6 at the other end face of the excitation fiber 500. Similarly, second signal light input to the core 7 can be caused to propagate through the core 7 to the core 12 and be output from the core 12. Furthermore, third signal light input to the core 13 can be caused to propagate through the core 13 to the core 18 and be output from the core 18.

Thus, by dividing the 18 cores into 3 groups by sixes, the excitation fiber 500 can independently amplify the first to third signal light. Each beam of the first to third signal light propagates six cores (that is, the core 1 to the core 6, the core 7 to the core 12, or the core 13 to the core 18) in the excitation fiber 500. Therefore, the excitation fiber 500 provides a greater effect of extending the length of a core for amplification than the excitation fiber 400.

The excitation fiber 500 includes the core 19 at the center. The core 19 is not included in optical paths of light propagating through the cores 1 to 18. The core 19 may be singly used as an optical amplifier with the length of one excitation fiber 500. For example, the cores 1 to 18 may be used for amplification of signal light in the L-band, and the core 19 may be used for amplification of signal light in the C-band.

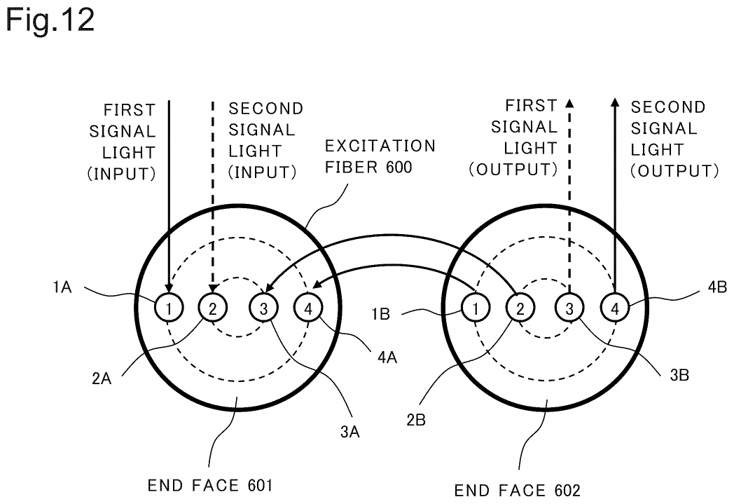

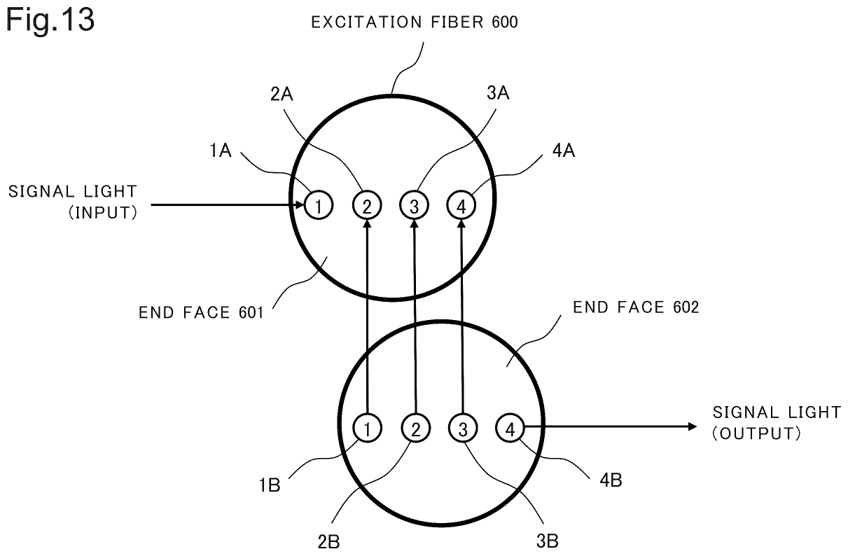

FIG. 12 is a diagram illustrating an example of core placement of an excitation fiber 600. The excitation fiber 600 includes a core 1 to a core 4. The core 1 to the core 4 of the excitation fiber 600 are equidistantly spaced on a straight line passing through a section of the excitation fiber 600. In the example in FIG. 13, the core 1 to the core 4 are equidistantly spaced on a straight line passing through the center of the excitation fiber 600 at positions point-symmetric with respect to the center of the excitation fiber 600. By causing an end face 602 of such an excitation fiber 600 to rotate 180 degrees and face an end face 601, first signal light input to an end face 1A of the core 1 can be caused to propagate through the core 1 and the core 4 and be output from an end face 4B of the core 4. Furthermore, second signal light input to an end face 2A of the core 2 can be caused to propagate through the core 2 and the core 3 and be output from an end face 3B of the core 3.

FIG. 13 is a diagram illustrating another facing example of the excitation fiber 600. For ease of understanding, the end face 601 indicates core placement viewed from outside the excitation fiber 600, and the end face 602 indicates core placement at the end face 602 virtually viewed from inside the excitation fiber 600 in this diagram. Further, in order to clearly indicate the positions of the end faces of the cores 1 to 4 at the end faces 601 and 602, the end face 602 is shifted downward in the illustration in FIG. 13.

In FIG. 13, when the end face 601 and the end face 602 of the excitation fiber 600 face each other, the position of the end face 602 in the lateral direction is laterally shifted relative to the end face 101 by a spacing of one core. Specifically, in a state of the end face 601 facing the end face 602, an end face 1B and the end face 2A, an end face 2B and an end face 3A, and the end face 3B and an end face 4A respectively face each other.

Signal light is input to the end face 1A of the core 1. The input signal light is input to the end face 2A from the end face 1B and propagates through the core 2. The signal light propagates through the core 2 to the core 4 and is output from the end face 4B of the core 4. The end face 1A of the core to which the signal light is input does not face the end face 4B of the core from which the signal light is output in the configuration in FIG. 13; and therefore, the mirror 801 in FIG. 4 or the like for input and output of signal light is not necessary, which simplifies the configuration of the MCF optical amplifier 1000.

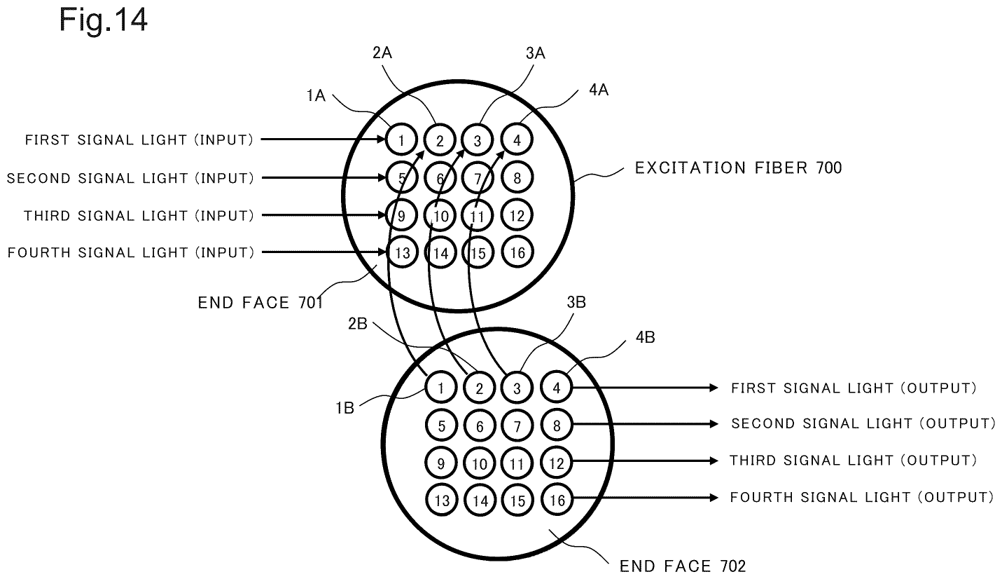

FIG. 14 is a diagram illustrating a facing example of an excitation fiber 700. The excitation fiber 700 includes a core 1 to a core 16. The core 1 to the core 16 of the excitation fiber 700 are placed in four rows and four columns on a section of the excitation fiber 700. The rows are equidistantly spaced, and the columns are also equidistantly spaced. An end face 701 of the excitation fiber 700 indicates core placement viewed from outside the excitation fiber 700, and an end face 702 indicates core placement virtually viewed from inside the excitation fiber 700 in this diagram as well. In order to clearly indicate the positions of end faces of the cores 1 to 16 at the end faces 701 and 702, the end face 702 is shifted downward in the illustration in FIG. 14. Reference signs of the end faces of the core 5 to the core 16 are omitted in the drawing.

The end face 701 and the end face 702 are placed in such a way that an end face 1B to an end face 3B and an end face 2A to an end face 4A respectively face each other on a one-to-one basis. Similarly, an end face 5B to an end face 7B and an end face 6A to an end face 8A respectively face each other on a one-to-one basis, an end face 9B to an end face 11B and an end face 10A to an end face 12A respectively face each other on a one-to-one basis, and an end face 13B to an end face 15B and an end face 14A to an end face 16A respectively face each other on a one-to-one basis.

First signal light is input to the end face 1A of the core 1. The first signal light is input to the end face 2A from the end face 1B and propagates through the core 2. Then, the first signal light propagates through the core 2 to the core 4 and is output from the end face 4B of the core 4. Second signal light input to the core 5 is input to the end face 6A from the end face 5B and propagates through the core 6. The second signal light propagates through the core 6 to the core 8 and is output from the end face 8B of the core 8. Similarly, third signal light input to the core 9 propagates through the cores 9 to 12 and is output from the end face 12B of the core 12. Fourth signal light input to the core 13 propagates through the cores 13 to 16 and is output from the end face 16B of the core 16. End faces of the core for inputting signal light and the core for outputting signal light do not face each other in the configuration using the excitation fiber 700 in FIG. 14, similarly to FIG. 13. Therefore, optical paths to the outside for input and output of signal light can be more easily configured. Further, the excitation fiber 700 can simultaneously and independently amplify four beams of signal light.

The example embodiments of the present disclosure may also be described as, but not limited to, the following Supplementary Notes.

### Supplementary Note 1

A multi-core fiber optical amplifier including:
a multi-core excitation fiber configured to include a first core and a second core; and
a clad excitation means for injecting excitation light into a clad of the multi-core excitation fiber, wherein
signal light input to an one end of the first core is output from an other end of the first core,
the signal light output from the other end of the first core is input to an one end of the second core, and
the signal light input to one end of the second core is output from an other end of the second core.

### Supplementary Note 2

The multi-core fiber optical amplifier according to Supplementary Note 1, wherein
the first core and the second core are equidistantly spaced on a circumference around a center of an end face of the multi-core excitation fiber, and
the other end of the first core is optically coupled to the one end of the second core by maintaining an other end of the multi-core excitation fiber in a state of being rotated by a predefined angle relative to an one end of the multi-core excitation fiber.

### Supplementary Note 3

The multi-core fiber optical amplifier according to Supplementary Note 1 or 2, wherein
the multi-core excitation fiber includes a third core,
the signal light output from the other end of the second core is input to an one end of the third core, and
the signal light input to the one end of the third core is output from an other end of the third core.

### Supplementary Note 4

The multi-core fiber optical amplifier according to Supplementary Note 1 or 2, wherein
the other end of the first core is optically coupled to the one end of the second core by shifting a center of the one end of the multi-core excitation fiber from a center of the other end of the multi-core excitation fiber.

### Supplementary Note 5

The multi-core fiber optical amplifier according to any one of Supplementary Notes 1 to 4, wherein
optical coupling is performed between the other end of the first core and the one end of the second core by optical collimators facing each other.

### Supplementary Note 6

The multi-core fiber optical amplifier according to Supplementary Note 5, further including,
between the optical collimators facing each other, a mirror configured to couple the signal light to the first core by reflecting the signal light.

### Supplementary Note 7

The multi-core fiber optical amplifier according to Supplementary Note 6, wherein
the mirror couples the first core to the excitation light by reflecting the excitation light.

### Supplementary Note 8

The multi-core fiber optical amplifier according to Supplementary Note 6 or 7, wherein
the clad excitation means includes a wavelength filter configured to be placed between the optical collimators facing each other and guide the excitation light input from outside the multi-core excitation fiber to a clad of the multi-core excitation fiber.

### Supplementary Note 9

The multi-core fiber optical amplifier according to Supplementary Note 8, wherein
the wavelength filter causes the signal light to propagate from the other end of the first core to end of the second core by transmitting light at a wavelength of the signal light.

### Supplementary Note 10

The multi-core fiber optical amplifier according to Supplementary Note 8 or 9, wherein
the wavelength filter is formed in a part of the mirror.

### Supplementary Note 11

An optical amplification method used in a multi-core fiber optical amplifier including a multi-core excitation fiber including a first core and a second core, the method including:
injecting excitation light into a clad of the multi-core excitation fiber;
outputting signal light input to an one end of the first core from an other end of the first core;
inputting the signal light output from another end of the first core to one end of the second core; and
outputting the signal light input to the one end of the second core from the other end of the second core.

### Supplementary Note 12

The optical amplification method according to Supplementary Note 11, further including:
equidistantly spacing the first core and the second core on a circumference around a center of an end face of the multi-core excitation fiber;
rotating an other end of the multi-core excitation fiber by a predefined angle relative to an one end of the multi-core excitation fiber; and
optically coupling the other end of the first core to the one end of the second core.

### Supplementary Note 13

The optical amplification method according to Supplementary Note 11 or 12, further including:
inputting the signal light output from the other end of the second core to an one end of a third core of the multi-core excitation fiber; and
outputting the signal light input to the one end of the third core from an other end of the third core.

### Supplementary Note 14

The optical amplification method according to Supplementary Note 11 or 12, further including:
shifting a center of an one end of the multi-core excitation fiber from a center of an other end of the multi-core excitation fiber; and
optically coupling the other end of the first core to the one end of the second core.

### Supplementary Note 15

The optical amplification method according to any one of Supplementary Notes 11 to 14, further including
performing optical coupling between the other end of the first core and the one end of the second core by optical collimators facing each other.

### Supplementary Note 16

The optical amplification method according to Supplementary Note 15, further including,
by a mirror provided between the optical collimators facing each other, coupling the signal light to the first core by reflecting the signal light.

### Supplementary Note 17

The optical amplification method according to Supplementary Note 16, further including,
by the mirror, coupling the first core to the excitation light by reflecting the excitation light.

### Supplementary Note 18

The optical amplification method according to Supplementary Note 16 or 17, further including,
by a wavelength filter placed between the optical collimators facing each other, guiding the excitation light input from outside the multi-core excitation fiber to a clad of the multi-core excitation fiber.

### Supplementary Note 19

The optical amplification method according to Supplementary Note 18, further including, by the wavelength filter:
transmitting light at a wavelength of the signal light; and
causing the signal light to propagate from the another end of the first core to the one end of the second core.

### Supplementary Note 20

The optical amplification method according to Supplementary Note 18 or 19, wherein
the wavelength filter is formed in a part of the mirror.
While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims. For example, the multi-core fiber optical amplifier described in each example embodiment also discloses an optical amplification method applicable to the multi-core fiber optical amplifier.

The configurations described in the example embodiments are not necessarily exclusive to each other. The advantageous effects of the present invention may be provided by configurations acquired by combining the aforementioned example embodiments in whole or in part.

1. A multi-core fiber optical amplifier comprising:
a multi-core excitation fiber configured to include a first core and a second core; and
a clad excitation circuit configured to inject excitation light into a clad of the multi-core excitation fiber, wherein
signal light input to an one end of the first core is output from an other end of the first core,
the signal light output from the other end of the first core is input to an one end of the second core, and
the signal light input to the one end of the second core is output from an other end of the second core.

2. The multi-core fiber optical amplifier according to claim 1, wherein
the first core and the second core are equidistantly spaced on a circumference around a center of an end face of the multi-core excitation fiber, and
the other end of the first core is optically coupled to the one end of the second core by maintaining an other end of the multi-core excitation fiber in a state of being rotated by a predefined angle relative to an one end of the multi-core excitation fiber.

3. The multi-core fiber optical amplifier according to claim 1, wherein
the multi-core excitation fiber includes a third core,
the signal light output from the other end of the second core is input to an one end of the third core, and
the signal light input to the one end of the third core is output from an other end of the third core.

4. The multi-core fiber optical amplifier according to claim 2, wherein
the multi-core excitation fiber includes a third core,
the signal light output from the other end of the second core is input to an one end of the third core, and
the signal light input to the one end of the third core is output from an other end of the third core.

5. The multi-core fiber optical amplifier according to claim 1, wherein
the other end of the first core is optically coupled to the one end of the second core by shifting a center of the one end of the multi-core excitation fiber from a center of the other end of the multi-core excitation fiber.

6. The multi-core fiber optical amplifier according to claim 2, wherein
the other end of the first core is optically coupled to the one end of the second core by shifting a center of the one end of the multi-core excitation fiber from a center of the other end of the multi-core excitation fiber.

7. The multi-core fiber optical amplifier according to claim 1, wherein
optical coupling is performed between the other end of the first core and the one end of the second core by optical collimators facing each other.

8. The multi-core fiber optical amplifier according to claim 7, further comprising,
between the optical collimators facing each other, a mirror configured to couple the excitation light to the first core by reflecting the signal light.

9. The multi-core fiber optical amplifier according to claim 8, wherein
the mirror couples the excitation light to the first core by reflecting the excitation light.

10. The multi-core fiber optical amplifier according to claim 2, wherein
optical coupling is performed between the other end of the first core and the one end of the second core by optical collimators facing each other.

11. The multi-core fiber optical amplifier according to claim 8, wherein
the clad excitation circuit includes a wavelength filter configured to be placed between the optical collimators facing each other and guide the excitation light input from outside the multi-core excitation fiber to a clad of the multi-core excitation fiber.

12. The multi-core fiber optical amplifier according to claim 11, wherein
the wavelength filter causes the signal light to propagate from the other end of the first core to the one end of the second core by transmitting light at a wavelength of the signal light.

13. The multi-core fiber optical amplifier according to claim 11, wherein
the wavelength filter is formed in a part of the mirror.

14. An optical amplification method used in a multi-core fiber optical amplifier including a multi-core excitation fiber including a first core and a second core, the method comprising:
injecting excitation light into a clad of the multi-core excitation fiber;
outputting signal light input to an one end of the first core from an other end of the first core;
inputting the signal light output from the other end of the first core to an one end of the second core; and
outputting the signal light input to the one end of the second core from an other end of the second core.

15. The optical amplification method according to claim 14, further comprising:
equidistantly spacing the first core and the second core on a circumference around a center of an end face of the multi-core excitation fiber;
rotating an other end of the multi-core excitation fiber by a predefined angle relative to an one end of the multi-core excitation fiber; and
optically coupling the other end of the first core to the one end of the second core.

16. The optical amplification method according to claim 14, further comprising:
inputting the signal light output from the other end of the second core to an one end of a third core of the multi-core excitation fiber; and
outputting the signal light input to the one end of the third core from an other end of the third core.

17. The optical amplification method according to claim 14, further comprising:
shifting a center of an one end of the multi-core excitation fiber from a center of an other end of the multi-core excitation fiber; and
optically coupling the other end of the first core to the one end of the second core.

18. The optical amplification method according to claim 14, further comprising
performing optical coupling between the other end of the first core and the one end of the second core by optical collimators facing each other.

19. The optical amplification method according to claim 18, further comprising,
by a mirror provided between the optical collimators facing each other, coupling the signal light to the first core by reflecting the signal light.

20. The optical amplification method according to claim 19, further comprising,
by the mirror, coupling the excitation light to the first core by reflecting the excitation light.
